(19) United States
(12) Patent Application Publication
(10) Pub. No.: US 2024/0145162 A1
(43) Pub. Date: May 2, 2024

(54) COIL COMPONENT

(71) Applicant: SAMSUNG ELECTRO-MECHANICS CO., LTD., Suwon-si (KR)

(72) Inventors: Sang Jin KIM, Suwon-si (KR); Boum Seock KIM, Suwon-si (KR); Jung Su HWANGBO, Suwon-si (KR); Han LEE, Suwon-si (KR); Jung Min PARK, Suwon-si (KR)

(73) Assignee: SAMSUNG ELECTRO-MECHANICS CO., LTD., Suwon-si (KR)

(21) Appl. No.: 18/368,374

(22) Filed: Sep. 14, 2023

(30) Foreign Application Priority Data
Nov. 1, 2022 (KR) 10-2022-0143683

(51) Int. Cl. H01F 27/30; H01F 27/29

(52) U.S. Cl. CPC H01F 27/306; H01F 27/292; H01F 27/327

(57) ABSTRACT

A coil component includes: a body having a first and a second surface opposing each other, and a third and a fourth surface opposing each other and connecting the first surface and second surface; a support member disposed within the body; first and second coils disposed on the support member; first and third external electrodes disposed on the body and connected to the first coil; second and fourth external electrodes disposed on the body and connected to the second coil; a first via electrode disposed within the body and connecting the first coil and the first external electrode; and a second via electrode disposed within the body and connecting the second coil and the second external electrode, wherein the first to fourth external electrodes are disposed on the first surface, the third external electrode extends onto the third surface, and the fourth external electrode extends onto the fourth surface.

### CROSS-REFERENCE TO RELATED APPLICATION(S)

This application claims benefit of priority to Korean Patent Application No. 10-2022-0143683 filed on Nov. 1, 2022 in the Korean Intellectual Property Office, the disclosure of which is incorporated herein by reference in its entirety.

### BACKGROUND

### 1. Field

The present disclosure relates to a coil component.

### 2. Description of Related Art

An inductor, a coil component, is a representative passive electronic component used in an electronic device together with a resistor and a capacitor.

As electronic devices gradually become more sophisticated and miniaturized, the number of electronic components used in electronic devices has also increased and their sizes have been miniaturized.

In particular, a coupled inductor in which two or more coils, magnetically coupled to each other, are disposed within one coil component may have four terminals, and in general, the four terminals may respectively be disposed on side surfaces of the coil component and extend to their mounting surfaces.

### SUMMARY

An aspect of the present disclosure may prevent a short circuit occurring between external electrodes disposed on side surfaces of a coil component in the coupled inductor and a short circuit occurring between the external electrode and a part adjacent thereto by minimizing a region of the external electrode disposed on the side surface of the coil component.

Another aspect of the present disclosure may improve an appearance defect which may occur during insulation of a side surface of a coil component.

Another aspect of the present disclosure may improve an inductance characteristic by increasing an effective volume of a coil component filled with a magnetic material.

According to an aspect of the present disclosure, a coil component may include: a body having a first surface and a second surface opposing each other in a first direction, and a third surface and a fourth surface opposing each other and connecting the first surface and second surface to each other; a support member disposed within the body; first and second coils disposed on the support member; first and third external electrodes disposed on the body and connected to the first coil; second and fourth external electrodes disposed on the body and connected to the second coil; a first via electrode disposed within the body and connecting the first coil and the first external electrode to each other; and a second via electrode disposed within the body and connecting the second coil and the second external electrode to each other, wherein the first to fourth external electrodes are disposed on the first surface, the third external electrode extends onto the third surface, and the fourth external electrode extends onto the fourth surface.

According to another aspect of the present disclosure, a coil component may include: a body having a first surface and a second surface opposing each other; a support member disposed within the body; first and second coils disposed on the support member; first and third external electrodes disposed on the first surface and connected to the first coil; second and fourth external electrodes disposed on the first surface and connected to the second coil; first and third via electrodes disposed within the body and respectively connecting the first coil and the first and third external electrodes to each other; and second and fourth via electrodes disposed within the body and respectively connecting the second coil and the second and fourth external electrodes to each other.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view schematically illustrating a coil component according to a first exemplary embodiment of the present disclosure;

FIG. 2 is an assembled perspective view illustrating a connection relationship between first and second coils;

FIG. 3 is a lower perspective view of FIG. 1;

FIG. 4 is a view illustrating a cross-section taken along line I-I′ of FIG. 1 and an enlarged view of a region A;

FIG. 5 is a view illustrating a cross-section taken along line II-II′ of FIG. 1;

FIG. 6 is an upper surface view of FIG. 1;

FIG. 7 is a bottom view of FIG. 1;

FIG. 8 is a perspective view schematically illustrating a coil component according to a second exemplary embodiment of the present disclosure;

FIG. 9 is a view illustrating a cross-section taken along line III-III′ of FIG. 8;

FIG. 10 is a perspective view schematically illustrating a coil component according to a third exemplary embodiment of the present disclosure; and

FIG. 11 is a view illustrating a cross-section taken along line IV-IV′ of FIG. 10.

### DETAILED DESCRIPTION

Hereinafter, exemplary embodiments of the present disclosure will now be described in detail with reference to the accompanying drawings.

In the drawings, a T direction refers to a first direction or thickness direction, an L direction refers to a second direction or length direction, and a W direction refers to a third direction or a width direction.

Hereinafter, a coil component according to exemplary embodiments of the present disclosure will be described in detail with reference to the accompanying drawings. In describing the exemplary embodiments of the present disclosure with reference to the accompanying drawings, components that are the same as or correspond to each other will be denoted by the same reference numerals, and an overlapping descriptions thereof will be omitted.

Various types of electronic components may be used in an electronic device, and various kinds of coil components may be appropriately used between these electronic components depending on their purposes in order to remove noise or the like.

That is, the coil component used in the electronic device may be a power inductor, high frequency (HF) inductor, a general bead, a bead for a high frequency (GHz), a common mode filter, or the like.

### First Exemplary Embodiment

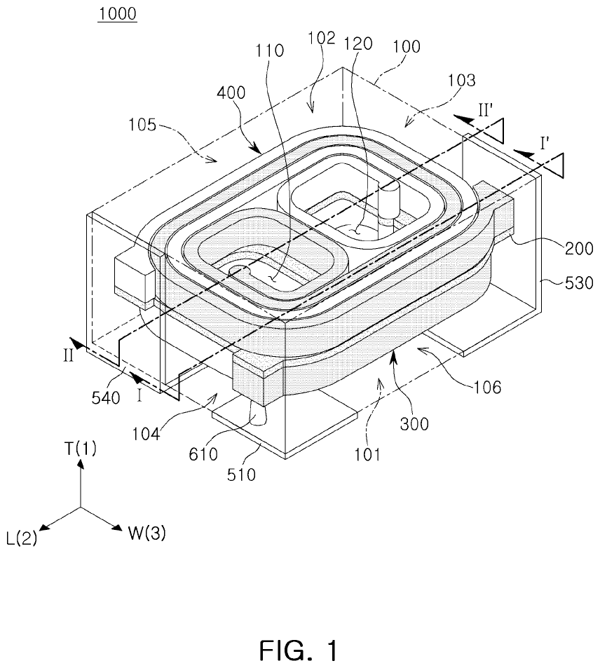

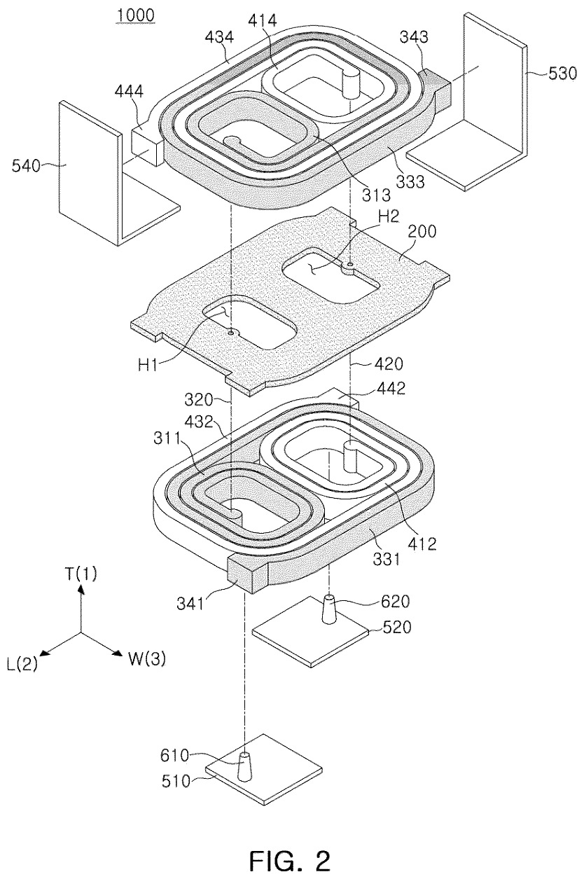

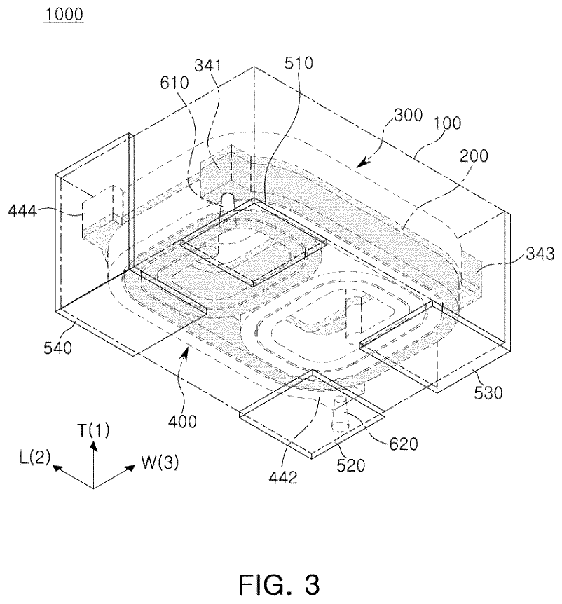

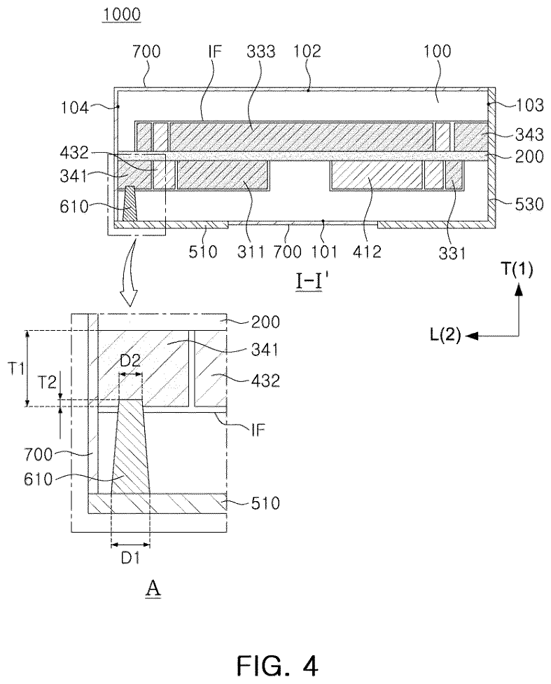

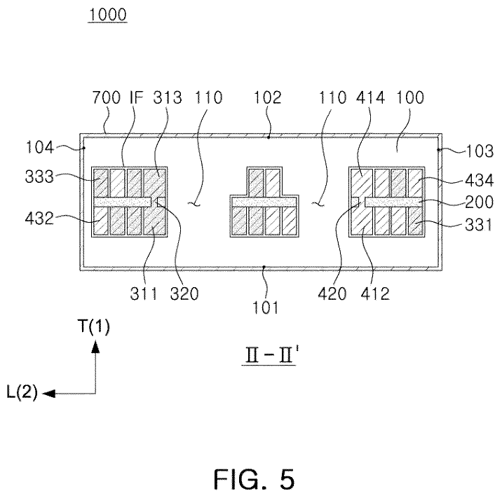

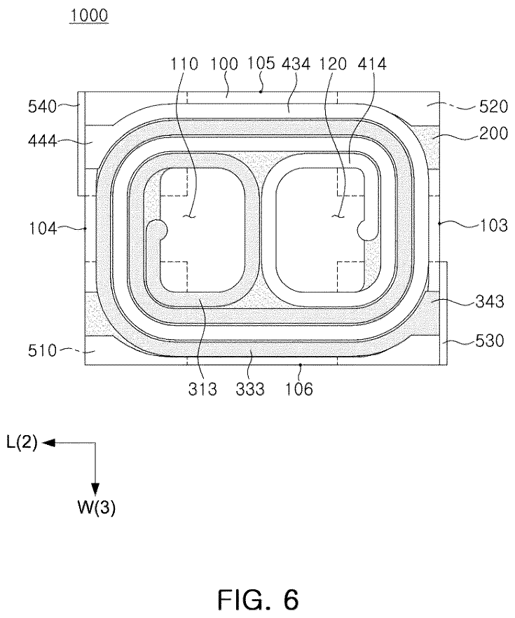

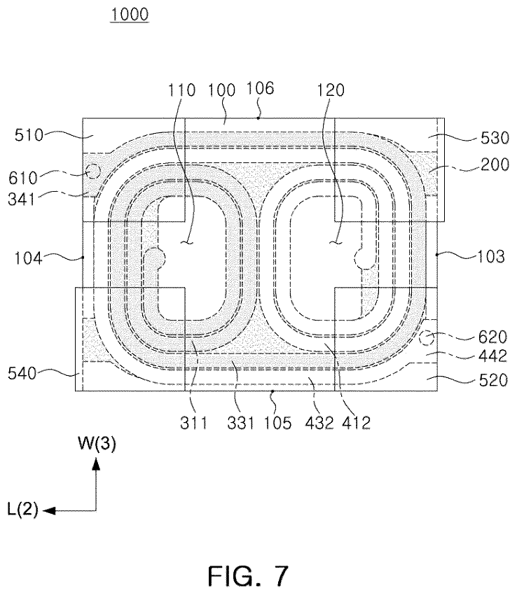

FIG. 1 is a perspective view schematically illustrating a coil component 1000 according to a first exemplary embodiment of the present disclosure; FIG. 2 is an assembled perspective view illustrating a connection relationship between first and second coils 300 and 400; FIG. 3 is a lower perspective view of FIG. 1; FIG. 4 is a cross-sectional view taken along line I-I′ of FIG. 1 and an enlarged view of a region A; FIG. 5 is a view illustrating a cross-section taken along line II-II′ of FIG. 1; FIG. 6 is an upper surface view of FIG. 1; and FIG. 7 is a bottom view of FIG. 1.

Meanwhile, an insulating layer 700 disposed on the body 100 is omitted in FIGS. 1 through 3, 6 and 7 to more clearly show coupling between components.

Referring to FIGS. 1 through 7, the coil component 1000 according to a first exemplary embodiment of the present disclosure may include a body 100, a support member 200, first and second coils 300 and 400, first to fourth external electrodes 510, 520, 530 and 540, and first and second via electrodes 610 and 620.

The coil component 1000 according to the present exemplary embodiment may include the first and second coils 300 and 400 disposed within the body 100 while being magnetically coupled to each other and physically spaced apart from each other, and the first to fourth external electrodes 510, 520, 530, and 540 connected to the first and second coils 300 and 400. In detail, both ends of the first coil 300 may respectively be connected to the first and third external electrodes 510 and 530, and both ends of the second coil 400 may respectively be connected to the second and fourth external electrodes 520 and 540.

Here, one end of the first coil 300 may be connected to the first external electrode 510 disposed on a lower surface of the body 100 through the first via electrode 610, and the other end of the first coil 300 may be directly connected to the third external electrode 530 disposed on a side surface of the body 100. In addition, one end of the second coil 400 may be connected to the second external electrode 520 disposed on the lower surface of the body 100 through the second via electrode 620, and the other end of the second coil 400 may be directly connected to the fourth external electrode 540 disposed on the side surface of the body 100. That is, two terminals among four terminals of a coupled inductor may be connected to the side surface and the other two terminals may be connected to the lower surface.

Through this structure, two external electrodes may not be disposed together on one side surface of the body 100 of the coupled inductor. It is thus possible to reduce a possibility of a short circuit occurring between the external electrodes disposed on the side surfaces or a short circuit occurring between the external electrode disposed on the side surface and a part adjacent thereto. It is also possible to simplify a process of disposing the insulating layer 700 on the side and bottom surfaces of the body 100, thus reducing appearance defects and increasing process efficiency.

Hereinafter, the description specifically describes the main components included in the coil component 1000 according to the present exemplary embodiment.

The body 100 may form an appearance of the coil component 1000 according to the present exemplary embodiment, and may embed the support member 200 and the first and second coils 300 and 400.

The body 100 may generally have a hexahedral shape. The body 100 may have a first surface and a second surface opposing each other in the thickness (T) or first direction, a third surface and a fourth surface opposing each other in the length (L) or second direction, and a fifth surface and a sixth surface opposing each other in the width (W) or third direction. Each of the third to sixth surfaces of the body 100 may correspond to a wall surface of the body 100 connecting the first and second surfaces of the body 100 to each other.

For example, the body 100 may be formed for the coil component 1000 according to the present exemplary embodiment including the external electrodes 510, 520, 530, and 540 described below to have: a length of 2.5 mm, a width of 2.0 mm, and a thickness of 1.0 mm; a length of 2.0 mm, a width of 1.2 mm, and a thickness of 0.65 mm; a length of 1.6 mm, a width of 0.8 mm, and a thickness of 0.8 mm; a length of 1.0 mm, a width of 0.5 mm, and a thickness of 0.8 mm; or a length of 0.8 mm, a width of 0.4 mm, and a thickness of 0.65 mm. However, the present disclosure is not limited thereto. Meanwhile, the above exemplary dimensions for the length, width, and thickness of the coil component 1000 may be dimensions that do not reflect process errors, and a range of the dimensions recognized to include the process errors may thus fall within that of the above-described exemplary dimensions.

The above length of the coil component 1000 may indicate the maximum value of respective dimensions of a plurality of line segments spaced apart from each other in the thickness (T) direction, and connecting two outermost boundary lines opposing each other in the length (L) direction of the coil component 1000 shown in the following image to be parallel to the length (L) direction, based on the optical microscope image or scanning electron microscope (SEM) image of a cross-section of the coil component 1000 in a length (L)-thickness (T) direction that is taken from its center in the width (W) direction. Alternatively, the length of the coil component 1000 may indicate the minimum value of the respective dimensions of the plurality of line segments described above. Alternatively, the length of the coil component 1000 may indicate an arithmetic average value of at least three of the respective dimensions of the plurality of line segments described above. Here, the plurality of line segments parallel to the length (L) direction may be equally spaced from each other in the thickness (T) direction, and the scope of the present disclosure is not limited thereto.

The above thickness of the coil component 1000 may indicate the maximum value of respective dimensions of a plurality of line segments spaced apart from each other in the length (L) direction, and connecting two outermost boundary lines opposing each other in the thickness (T) direction of the coil component 1000 shown in the following image to be parallel to the thickness (T) direction, based on the optical microscope image or scanning electron microscope (SEM) image of the cross-section of the coil component 1000 in the length (L)-thickness (T) direction that is taken from its center in the width (W) direction. Alternatively, the thickness of the coil component 1000 may indicate the minimum value of the respective dimensions of the plurality of line segments described above. Alternatively, the thickness of the coil component 1000 may indicate an arithmetic average value of at least three of the respective dimensions of the plurality of line segments described above. Here, the plurality of line segments parallel to the thickness (T) direction may be equally spaced from each other in the length (L) direction, and the scope of the present disclosure is not limited thereto.

The above width of the coil component 1000 may indicate the maximum value of respective dimensions of a plurality of line segments spaced apart from each other in the length (L) direction, and connecting two outermost boundary lines opposing each other in the width (W) direction of the coil component 1000 shown in the following image to be parallel to the width (W) direction, based on the optical microscope image or scanning electron microscope (SEM) image of a cross-section of the coil component 1000 in a length (L)-width (W) direction that is taken from its center in the thickness (T) direction. Alternatively, the width of the coil component 1000 may indicate the minimum value of the respective dimensions of the plurality of line segments described above. Alternatively, the width of the coil component 1000 may indicate an arithmetic average value of at least three of the respective dimensions of the plurality of line segments described above. Here, the plurality of line segments parallel to the width (W) direction may be equally spaced from each other in the length (L) direction, and the scope of the present disclosure is not limited thereto.

Alternatively, each of the length, width and thickness of the coil component 1000 may be measured using a micrometer measurement method. The micrometer measurement method may be used by setting a zero point with a micrometer using a repeatability and reproducibility (Gage R&R), inserting the coil component 1000 according to the present exemplary embodiment between tips of the micrometer, and turning a measurement lever of the micrometer. Meanwhile, when measuring the length of the coil component 1000 by using the micrometer measurement method, the length of the coil component 1000 may indicate a value measured once or an arithmetic average of values measured several times. This method may be equally applied to measure the width or thickness of the coil component 1000.

The body 100 may include a magnetic material and resin. In detail, the body 100 may be formed by laminating one or more magnetic composite sheets in which the magnetic material is dispersed in the resin. However, the body 100 may also have a structure other than the structure in which the magnetic material is dispersed in the resin. For example, the body 100 may be formed of a magnetic material such as ferrite or a non-magnetic material.

The magnetic material may be the ferrite or metal magnetic powder particles.

The ferrite may be, for example, at least one of a spinel type ferrite such as Mg—Zn-based ferrite, Mn—Zn-based ferrite, Mn—Mg-based ferrite, Cu—Zn-based ferrite, Mg—Mn—Sr-based ferrite or Ni—Zn-based ferrite, a hexagonal type ferrite such as Ba—Zn-based ferrite, Ba—Mg-based ferrite, Ba—Ni-based ferrite, Ba—Co-based ferrite or Ba—Ni—Co-based ferrite, a garnet type ferrite such as Y-based ferrite, and Li-based ferrite.

The metal magnetic powder particles may include one or more selected from the group consisting of iron (Fe), silicon (Si), chromium (Cr), cobalt (Co), molybdenum (Mo), aluminum (Al), niobium (Nb), copper (Cu) and nickel (Ni). For example, the metal magnetic powder particles may be one or more of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder particles, Fe—Cr-based alloy powder particles, Fe—Cr—Si-based alloy powder particles, Fe—Si—Cu—Nb-based alloy powder particles, Fe—Ni—Cr-based alloy powder particles, and Fe—Cr—Al-based alloy powder particles

The metal magnetic powder particles may be amorphous or crystalline. For example, the metal magnetic powder particles may be Fe—Si—B—Cr-based amorphous alloy powder particles, and are not necessarily limited thereto.

The ferrite and the metal magnetic powder particles may respectively have average diameters of about 0.1 μm to 30 μm, and are not limited thereto.

The body 100 may include two or more types of magnetic materials dispersed in the resin. Here, different types of magnetic materials may indicate that the magnetic materials dispersed in the resin are distinguishable from each other by any one of an average diameter, a composition, crystallinity, and a shape.

The resin may include epoxy, polyimide, liquid crystal polymer (LCP), or the like, or mixtures thereof, and is not limited thereto.

The body 100 may include a first core 110 passing through the support member 200 and the first coil 300, and a second core 120 passing through the support member 200 and the second coil 400.

Referring to FIGS. 2 and 5, the support member 200 may have a first through-hole H1 in which the first core 110 is disposed and a second through-hole H2 in which the second core 120 is disposed.

Each of the first and second cores 110 and 120 may be formed by at least a portion of a magnetic composite sheet filling each through-hole of the first and second coil parts 300 and 400 in the process of laminating and curing the magnetic composite sheet, and is not limited thereto.

The support member 200 may be disposed within the body 100. The support member 200 is a component supporting the first and second coils 300 and 400.

Meanwhile, the support member 200 may be excluded in some exemplary embodiments, such as a case in which the first and second coils 300 and 400 correspond to wound coils or the coil has a coreless structure.

The support member 200 may be formed of an insulating material including thermosetting insulating resin such as epoxy resin, thermoplastic insulating resin such as polyimide, or photosensitive insulating resin, or may be formed of an insulating material having a reinforcement material such as a glass fiber or an inorganic filler impregnated in the insulating resin. For example, the support member 200 may be formed of a material such as prepreg, an Ajinomoto Build-up Film (ABF), FR-4, bismaleimide triazine (BT) resin, a photo imagable dielectric (PID) or a copper clad laminate (CCL), and is not limited thereto.

The inorganic filler may use one or more materials selected from the group consisting of silica (or silicon dioxide, SiO₂), alumina (or aluminum oxide, Al₂O₃), silicon carbide (SiC), barium sulfate (BaSO₄), talc, clay, mica powder particles, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

Here, when formed of the insulating material including the reinforcing material, the support member 200 may have more excellent rigidity. The support member 200 may be formed of the insulating material including no glass fiber. In this case, an entire thickness of the support member 200 and the first and second coils 300 and 400 (indicating sum of the respective dimensions of the first and second coils 300 and 400 and the support member 200 in the thickness T direction of FIG. 1) may be thinned, which is advantageous to reduce the thickness of the component. The support member 200 may be formed of the insulating material including the photosensitive insulating resin. In this case, the number of processes for forming the first and second coils 300 and 400 may be reduced, which is advantageous in reducing a production cost, and fine vias 320 and 420 may also be formed. For example, the support member 200 may have a thickness of 10 μm or more and 50 μm or less, and is not limited thereto.

Referring to FIGS. 1 and 2, the first and second coils 300 and 400 may be disposed on the support member 200. The first coil 300 may be disposed on both surfaces of the support member 200, and the second coil 400 may also be disposed on both the surfaces of the support member 200.

The first and second coils 300 and 400 may be disposed on the support member 200 while being spaced apart from each other to thus express a characteristic of the coil component 1000 according to the present exemplary embodiment. For example, when the coil component 1000 of the present exemplary embodiment is used as the power inductor, first and second coils 300 and 400 may each store an electric field as a magnetic field to maintain an output voltage, thereby stabilizing power of the electronic device. In addition, the first and second coils 300 and 400 may be magnetically coupled to each other to function as the coupled inductor in which an absolute value of a coupling coefficient k is greater than zero and less than 1, and are not limited thereto.

Referring to FIGS. 2 and 5, the first coil 300 may include first and third winding portions 311 and 313 respectively disposed on both the surfaces of the support member 200 and wound around the first core 110, the first via 320 connecting the first and third winding portions 311 and 313 to each other, first and third extension portions 331 and 333 surrounding the first and second cores 110 and 120 together, a first lead portion 341 connected to the first via electrode 610, and a third lead portion 343 connected to the third external electrode 530.

In addition, the second coil 400 may include second and fourth winding portions 412 and 414 respectively disposed on both the surfaces of the support member 200 and wound around the second core 120, the second via 420 connecting the second and fourth winding portions 412 and 414 to each other, second and fourth extension portions 432 and 434 surrounding the first and second cores 110 and 120 together, a second lead portion 442 connected to the second via electrode 620, and a fourth lead portion 444 connected to the fourth external electrode 540.

Referring to FIGS. 2 and 6, the third winding portion 313, third extension portion 333, and third lead portion 343 of the first coil 300, and the fourth winding portion 414, fourth extension portion 434, and fourth lead portion 444 of the second coil 400 may be disposed on an upper surface of the support member 200.

The third winding portion 313 may have at least one turn formed around the first core 110, and the third extension portion 333 extending from the third winding portion 313 may surround the first and second cores 110 and 120 together. The third lead portion 343 disposed at an end of the third extension portion 333 may be connected to the third external electrode 530 disposed on the third surface 103 of the body 100.

In addition, the fourth winding portion 414 may have at least one turn formed around the second core 120, and the fourth extension portion 434 extending from the fourth winding portion 414 may surround the first and second cores 110 and 120 together. The fourth lead portion 444 disposed at an end of the fourth extension portion 434 may be connected to the fourth external electrode 540 disposed on the fourth surface 104 of the body 100.

Referring to FIGS. 1, 2 and 7, the first winding portion 311, first extension portion 331, and first lead portion 341 of the first coil 300, and the second winding portion 412, second extension portion 432, and second lead portion 442 of the second coil 400 may be disposed on a lower surface of the support member 200.

The first winding portion 311 may have at least one turn formed around the first core 110, and the first extension portion 331 extending from the first winding portion 311 may surround the first and second cores 110 and 120 together. The first lead portion 341 disposed at an end of the first extension portion 331 may be connected to the first external electrode 510 disposed on a first surface 101 of the body 100 through the first via electrode 610.

In addition, the second winding portion 412 may have at least one turn formed around the second core 120, and the second extension portion 432 extending from the second winding portion 412 may surround the first and second cores 110 and 120 together. The second lead portion 442 disposed at an end of the second extension portion 432 may be connected to the second external electrode 520 disposed on the first surface 101 of the body 100 through the second via electrode 620.

Referring to FIG. 5, the first winding portion 311 and third winding portion 313 of the first coil 300 may have inner ends connected to each other through the first via 320 passing through the support member 200. In addition, the second winding portion 412 and fourth winding portion 414 of the second coil 400 may have inner ends connected to each other through the second via 420 passing through the support member 200.

Through this structure, when the coil component 1000 according to the present exemplary embodiment is mounted on a printed circuit board or the like, a signal input to the first external electrode 510 may be output to the third external electrode 530 through the first via electrode 610, the first lead portion 341, the first extension portion 331, the first winding portion 311, the first via 320, the third winding portion 313, the third extension portion 333, and the third lead portion 343.

Accordingly, the first coil 300 and the first via electrode 610 may function as one coil between the first external electrode 510 and the third external electrode 530.

In addition, a signal input to the second external electrode 520 may be output to the fourth external electrode 540 through the second via electrode 620, the second lead portion 442, the second extension portion 432, the second winding portion 412, the second via 420, the fourth winding portion 414, the fourth extension portion 434, and the fourth lead portion 444.

Accordingly, the second coil 400 and the second via electrode 620 may function as one coil between the second external electrode 520 and the fourth external electrode 540.

Referring to FIG. 2, in the first coil 300, the first winding portion 311 and the first extension portion 331 may be wound in the same direction, and the third winding portion 313 and the third extension portion 333 may be wound in the same direction. Through this structure, when a current flows between the first external electrode 510 and the third external electrode 530, magnetic flux induced from the first winding portion 311 and a magnetic flux induced from the first extension portion 331 may have the same direction, and a magnetic flux induced from the third winding portion 313 and a magnetic flux induced from the third extension portion 333 may have the same direction.

Similarly, in the second coil 400, the second winding portion 412 and the second extension portion 432 may be wound in the same direction, and the fourth winding portion 414 and the fourth extension portion 434 may be wound in the same direction. Through this structure, when a current flows between the second external electrode 520 and the fourth external electrode 540, a magnetic flux induced from the second winding portion 412 and a magnetic flux induced from the second extension portion 432 may have the same direction, and a magnetic flux induced from the fourth winding portion 414 and a magnetic flux induced from the fourth extension portion 434 may have the same direction.

The first coil 300 and the second coil 400 may entirely have the same winding direction, and the first and second coils 300 and 400 wound in the same direction may be disposed within one body 100, as described above, thereby implementing the coupled inductor in which the first and second coils 300 and 400 are magnetically coupled to each other.

The absolute value of the magnetic coupling coefficient k between the first and second coils 300 and 400 may be greater than zero and less than 1, and it is possible to control positive coupling or negative coupling to be performed based on the input and output directions of the external electrodes 510, 520, 530, and 540.

At least one of the first to fourth winding portions 311, 412, 313, and 414, the first and second vias 320 and 420, the first to fourth extension portions 331, 432, 333, and 434, and the first to fourth lead portions 341, 442, 343, and 444 may include at least one conductive layer.

Taking the first coil 300 as an example, the first winding portion 311, the first via 320, the first extension portion 331, and the first lead portion 341 may be formed by performing plating on the lower surface of the support member 200 (based on the direction shown in FIG. 2). In this case, each of the first winding portion 311, the first via 320, the first extension portion 331, and the first lead portion 341 may include a seed layer and an electroplating layer. The seed layer may be formed by a vapor deposition method such as electroless plating or sputtering. Each of the seed layer and the electroplating layer may have a single-layer structure or a multi-layer structure. The electroplating layer having the multi-layer structure may be a conformal film in which another electroplating layer covers one electroplating layer, or may be a layer in which another electroplating layer is laminated on only one surface of one electroplating layer. The seed layer 310 of the first winding portion 311, the first via 320, the first extension portion 331, and the first lead portion 341 may be integrally formed to thus have no boundary therebetween, and are not limited thereto. The electroplating layer of the first winding portion 311, the first via 320, the first extension portion 331, and the first lead portion 341 may be integrally formed to thus have no boundary therebetween, but are not limited thereto.

Each of the first to fourth winding portions 311, 412, 313, and 414, the first and second vias 320 and 420, the first to fourth extension portions 331, 432, 333, and 434, and the first to fourth lead portions 341, 442, 343, and 444 may include a conductive material such as copper (Cu), aluminum (Al), silver (Ag), tin (Sn), gold (Au), nickel (Ni), lead (Pb), titanium (Ti), chromium (Cr), molybdenum (Mo), or alloys thereof, and is not limited thereto.

Referring to FIGS. 1 through 4, the coil component 1000 according to the present exemplary embodiment may include a first via electrode 610 disposed within the body 100 to connect the first coil 300 and the first external electrode 510 to each other, and a second via electrode 620 disposed within the body 100 to connect the second coil 400 and the second external electrode 520 to each other.

Referring to FIG. 4, at least one of the first via electrode 610 or second via electrode 620 may be tapered to have a wider cross-sectional area closer to the first surface 101 of the body 100. At least one of the first via electrode 610 or second via electrode 620 may have a trapezoidal cross-section on the L-T cross-section of the coil component 1000, and is not limited thereto.

The first via electrode 610 may have one surface in contact with the first coil 300, that is, one surface in contact with the first lead portion 341 of the first coil 300, and the other surface in contact with the first external electrode 510. In this case, one surface and the other surface of the first via electrode 610 may respectively be formed to have a circular shape. Here, one surface and the other surface formed to have the circular shape may indicate that the surface has a substantially circular shape including a process error due to a via hole processed using a laser or the like, and are not limited thereto.

A ratio D1/D2 of a diameter D1 of the other surface of the first via electrode 610, which is in contact with in contact with the first external electrode 510, to a diameter D2 of one surface of the first via electrode 610, which is in contact with the first lead portion 341 of the first coil 300, may be more than 1.05, but is not limited thereto. The ratio D1/D2 of the diameter D1 of the other surface of the first via electrode 610 to the diameter D2 of one surface of the first via electrode 610 may be 1.05 or less. In this case, the first via electrode 610 may have the substantially circular shape, thus having a lower hole-filling quality than in a case of having the tapered shape.

Similarly, the second via electrode 620 may have one surface in contact with the second coil 400, that is, one surface in contact with the second lead portion 442 of the second coil 400, and the other surface in contact with the second external electrode 520. In this case, one surface and the other surface of the second via electrode 620 may each be formed in the circular shape. Here, one surface and the other surface formed in the circular shape may indicate that the surface has the substantially circular shape including the process error due to the via hole processing using the laser or the like, and are not limited thereto.

A ratio D1/D2 of a diameter D1 of the other surface of the second via electrode 620 to a diameter D2 of one surface of the second via electrode 610 may be more than 1.05, and is not limited thereto. The ratio D1/D2 of the diameter D1 of the other surface of the second via electrode 620, which is in contact with the second external electrode 520, to the diameter D2 of one surface of the second via electrode 620, which is in contact with the second lead portion 442 of the second coil 400, may be 1.05 or less. In this case, the second via electrode 620 may have the shape close to a cylinder, thus having the lower hole-filling quality than in the case of having the tapered shape.

Here, referring to FIG. 4, the diameter of one surface or the other surface of the via electrode 610 or 620 may have a value acquired by measuring a dimension of one surface or the other surface of the via electrode 610 or 620 in the L direction based on the optical microscope image or scanning electron microscope (SEM) image of the L-T cross-section of the coil component 1000 that is polished to pass through the center of the via electrode 610 or 620.

As described above, the via electrodes 610 and 620 may have the tapered cylindrical shape to have the wider cross-sectional diameter as being closer to the first surface 101 of the body 100. In this case, it is easy to fill the laser-processed via hole with the conductive material by the plating, thereby improving connection reliability between the via electrodes 610 and 620 and the lead portions 341 and 442.

Referring to FIGS. 3 and 4, the first or second via electrode 610 or 620 may at least partially extend into the first or second lead portion 341 or 442. That is, the via electrodes 610 and 620 may be formed by disposing the first and second coils 300 and 400 on both the surfaces of the support member 200, then laminating a magnetic sheet to thus form the body 100, and filling the conductive material in the via hole formed using the laser or the like. Therefore, the via electrode 610 or 620 may partially pass into the first or second lead portion 341 or 442.

In this structure, a ratio T2/T1 of a thickness T2 of a region in the first or T direction, where the first or second via electrode 610 or 620 extends into the first or second lead portion 341 or 442 to a thickness T1 of the first or second lead portion 341 or 442 in the first or T direction may be less than 0.9, and is not limited thereto. The ratio T2/T1 of the thickness T2 of the region in the first or T direction, where the first or second via electrode 610 or 620 extends into the first or second lead portion 341 or 442 to the thickness T1 of the first or second lead portion 341 or 442 in the first or T direction may be 0.9 or more, which may increase a risk of occurrence of the short circuit between the via electrode and the coil disposed on the opposite side surface of the support member 200 or a coil turn adjacent thereto.

Referring to FIGS. 1 through 4, the first to fourth external electrodes 510, 520, 530, and 540 may be disposed on the first surface 101 of the body 100, the third external electrode 530 may extend to the third surface 103 of the body 100, and the fourth external electrode 540 may extend to the fourth surface 104 of the body 100.

In detail, the first to fourth external electrodes 510, 520, 530, and 540 may be disposed on the first surface 101 of the body 100 while being spaced apart from one another. Among these external electrodes, the first and second external electrodes 510 and 520 may respectively be in contact with the first and second via electrodes 610 and 620 on the first surface 101 of the body 100. The third external electrode 530 may extend to the third surface 103 of the body 100 to be in contact with the third lead portion 343, and the fourth external electrode 540 may extend to the fourth surface 104 of the body 100 to be in contact with the fourth lead portion 444.

That is, in the coil component 1000 according to the present exemplary embodiment, among the four external electrodes 510, 520, 530, and 540, the first and second external electrodes 510 and 520 may be connected on the lower surface of the body 100 to the first and second lead portions 341 and 442 by the via electrodes 610 and 620, respectively, and the third and fourth external electrodes 530 and 540 may be directly connected on the side surfaces of the body 100 to the lead portions 343 and 444, respectively.

Through this structure, one end of the first coil 300 may be connected to the first external electrode 510, on the lower surface, and the other end of the first coil 300 may be connected to the third external electrode 530, on the side surface; and one end of the second coil 400 may be connected to the second external electrode 520, on the lower surface, and the other end of the second coil 400 may be connected to the fourth external electrode 540, on the side surface. Accordingly, compared to a conventional coupled inductor, the coil component 1000 of the present exemplary embodiment may significantly reduce the risk of the short circuit occurring on the side surface, and also reduce the appearance defects as a process of insulating the side surface is simplified.

The first to fourth external electrodes 510, 520, 530, and 540 may electrically connect the coil component 1000 to the printed circuit board or the like when the coil component 1000 according to the present exemplary embodiment is mounted on the printed circuit board or the like. For example, each of the first to fourth external electrodes 510, 520, 530, and 540 disposed on one surface of the body 100 while being spaced apart from one another and a connection part of the printed circuit board may be electrically connected to each other.

Each of the first to fourth external electrodes 510, 520, 530, and 540 may be formed of the conductive material such as copper (Cu), aluminum (Al), silver (Ag), tin (Sn), gold (Au), nickel (Ni), lead (Pb), chromium (Cr), titanium (Ti) or alloys thereof, and is not limited thereto.

Each of the first to fourth external electrodes 510, 520, 530, and 540 may include a plurality of layers. For example, each of the first to fourth external electrodes 510, 520, 530, and 540 may include a first layer in contact with the first or second via electrode 610 or 620 or the third or fourth lead portion 343 or 444, and a second layer disposed on the first layer. Here, the first layer may be a conductive resin layer including conductive powder particles including at least one of copper (Cu) and silver (Ag) and insulating resin, or may be a copper (Cu) plating layer. The second layer may have a double layer structure of a nickel (Ni) plating layer and/or a tin (Sn) plating layer.

Referring to FIGS. 4 and 5, an insulating film IF may be disposed between the first and second coils 300 and 400 and the body 100 to cover the first and second coils 300 and 400. The insulating film IF may be disposed along the surface of the support member 200, and the first and second coils 300 and 400. The insulating film IF may be used for insulating the first and second coils 300 and 400 from the body 100, and include a well-known insulating material such as parylene. However, the present disclosure is not limited thereto. The insulating film IF may be formed by the vapor deposition method or the like, is not limited thereto, and may be formed by laminating an insulating film on both the surfaces of the support member 200.

Meanwhile, the coil component 1000 according to the present exemplary embodiment may further include the insulating layer 700 covering an outer surface of the body 100 and disposed within a region other than regions where the first to fourth external electrodes 510, 520, 530, and 540 are disposed to thus expose the first to fourth external electrodes 510, 520, 530, and 540.

The insulating layer may be formed, for example, by coating and curing an insulating material including the insulating resin on the surface of the body 100. In this case, the insulating layer may include at least one of thermoplastic resin such as polystyrene-based resin, vinyl acetate-based resin, polyester-based resin, polyethylene-based resin, polypropylene-based resin, polyamide-based resin, rubber-based resin, acrylic-based resin, thermosetting insulating resin such as phenol-based resin, epoxy-based resin, urethane-based resin, melamine-based resin, and alkyd-based resin, and the photosensitive insulating resin.

### Second Exemplary Embodiment

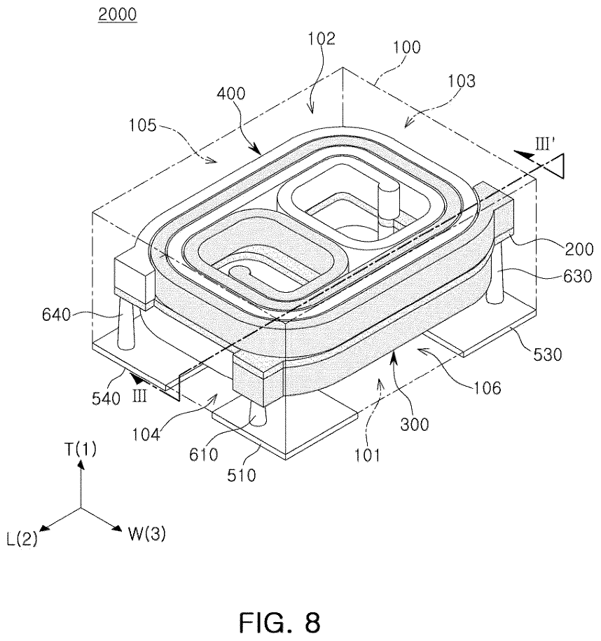

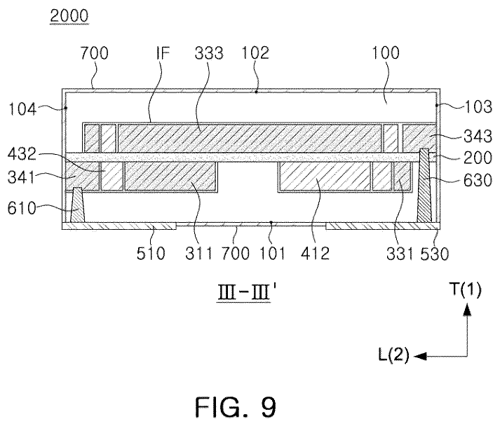

FIG. 8 is a perspective view schematically illustrating a coil component 2000 according to a second exemplary embodiment of the present disclosure; and FIG. 9 is a view illustrating a cross-section taken along line III-III′ of FIG. 8.

Referring to FIGS. 8 and 9, compared to a first exemplary embodiment, the present exemplary embodiment shows differences in a connection relationship between the third lead portion 343 and the third external electrode 530, a connection relationship between the fourth lead portion 444 and the fourth external electrode 540, shapes of the third and fourth external electrodes 530 and 540, and structures including the third and fourth via electrodes 630 and 640.

Therefore, in describing the present exemplary embodiment, the connection relationship between the third lead portion 343 and the third external electrode 530, the connection relationship between the fourth lead portion 444 and the fourth external electrode 540, the shapes of the third and fourth external electrodes 530 and 540, and the structures including the third and fourth via electrodes 630 and 640, which are different from those in a first exemplary embodiment of the present disclosure, are only described, and the descriptions of the other configurations in a first exemplary embodiment of the present disclosure may be equally applied to descriptions of those in the present exemplary embodiment.

Referring to FIGS. 8 and 9, in the coil component 2000 according to the present exemplary embodiment, the first to fourth external electrodes 510, 520, 530, and 540 may be disposed on the first surface 101 of the body 100, and may not extend to its side surface, that is, the third or sixth surfaces 103, 104, 105, or 106 of the body 100.

In addition, the coil component 2000 according to the present exemplary embodiment may include the first and third via electrodes 610 and 630 disposed within the body 100, the first via electrode 610 connecting the first coil 300 and the first external electrodes 510 to each other, and the second via electrode 630 connecting the first coil 300 and the third external electrode 530 to each other. The second and fourth via electrodes 620 and 640 disposed within the body 100, the second via electrode 620 connecting the second coil 400 and the second external electrode 520 to each other, and the fourth via electrode 640 connecting the second coil 400 and the fourth external electrode 540 to each other.

That is, compared to a first exemplary embodiment, the present exemplary embodiment may further include the third and fourth via electrodes 630 and 640. Through this structure, the first to fourth external electrodes 510, 520, 530, and 540 may be all disposed on the first surface 101 of the body 100, and each end of the first and second coils 300 and 400 may all be connected to the coils, on the lower surface.

Referring to FIG. 9, the third via electrode 630 may be connected to the first coil 300 by passing through the support member 200. In detail, the third via electrode 630 may pass through from the lower surface of the support member 200 toward the upper surface of the support member 200, and may come into contact with the third lead portion 343 of the first coil 300 disposed on the upper surface of the support member 200. Here, at least a portion of the third via electrode 630 may extend into the third lead portion 343.

In addition, the fourth via electrode 640 may be connected to the second coil 400 by passing through the support member 200. In detail, the fourth via electrode 640 may pass through from the lower surface of the support member 200 toward the upper surface of the support member 200, and may come into contact with the fourth lead portion 444 of the second coil 400 disposed on the upper surface of the support member 200. Here, at least a portion of the fourth via electrode 640 may extend into the fourth lead portion 434.

Like the first and second via electrodes 610 and 620, the third and fourth via electrodes 630 and 640 may each be formed by processing the via hole in the body 100 by using the laser or the like, and then filling the conductive material in the via hole. At least one of the third and fourth via electrodes 630 and 640 may be tapered to have a wider cross-sectional area as being closer to the first surface 101 of the body 100, and is not limited thereto.

The third via electrode 630 may have one surface in contact with the third lead portion 343 of the first coil 300, and the other surface in contact with the third external electrode 530. In this case, one surface and the other surface of the third via electrode 630 may each be formed in a circular shape. In addition, the fourth via electrode 640 may have one surface in contact with the fourth lead portion 444 of the second coil 400, and the other surface in contact with the fourth external electrode 540. In this case, one surface and the other surface of the fourth via electrode 640 may each be formed in the circular shape.

Here, one surface and the other surface formed in the circular shape may indicate that the surface has the a substantially circular shape including a process error due to a via hole processing using the laser or the like, and are not limited thereto.

Compared to a first exemplary embodiment, in the coil component 2000 according to the present exemplary embodiment, the first to fourth external electrodes 510, 520, 530, and 540 may be all disposed on the first surface 101 of the body 100, and the four terminals of the coupled inductor may thus be all implemented as lower surface electrodes. Through this structure, the external electrodes 510, 520, 530, and 540 may not be disposed on the side surface of the body 100. It is thus possible to further simplify the process of insulating the side surface, and further reduce the risk of the short circuit occurring on the side surface of the body 100.

### Third Exemplary Embodiment

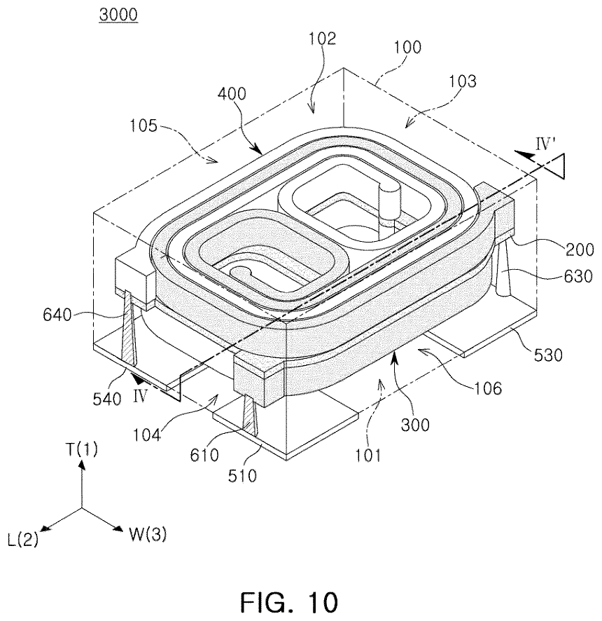

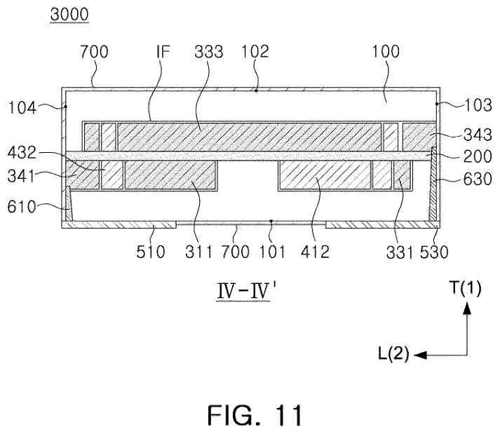

FIG. 10 is a perspective view schematically illustrating a coil component 3000 according to a third exemplary embodiment of the present disclosure; and FIG. 11 is a view illustrating a cross-section taken along line IV-IV′ of FIG. 10.

Referring to FIGS. 10 and 11, compared to a second exemplary embodiment, the present exemplary embodiment shows differences in shapes of the first to fourth via electrodes 610, 620, 630, and 640, and a disposition relationship between the first to fourth via electrodes 610, 620, 630, and 640 and the surface of the body 100.

Therefore, in describing the present exemplary embodiment, the shapes of the first to fourth via electrodes 610, 620, 630, and 640, and the disposition relationship between the first to fourth via electrodes 610, 620, 630, and 640 and the surface of the body 100, which are different from a second exemplary embodiment of the present disclosure are only described, and the descriptions of the other configurations in a second exemplary embodiment of the present disclosure may be equally applied to descriptions of those in the present exemplary embodiment.

Referring to FIG. 10, according to the present exemplary embodiment, the via electrodes 610, 620, 630, and 640 of the coil component 3000 may be partially cut off and disposed within contact with the side surfaces of the body 100. For example, each of the first to fourth via electrodes 610, 620, 630, and 640 may have a tapered semi-cylindrical shape, and is not limited thereto.

Referring to FIGS. 10 and 11, each of the first to fourth via electrodes 610, 620, 630, and 640 may have one surface in contact with the first coil 300 or the second coil 400, the other surface in contact with each of the first to fourth external electrodes 510, 520, 530, and 540, and a side surface connecting the one surface and the other surface to each other, and at least one of the first to fourth via electrodes 610, 620, 630, and 640 may have the side surface at least partially coplanar with the surface of the body 100.

In detail, at least one of the second and third via electrodes 620 and 630 may have the side surface of at least partially coplanar with the third surface 103 of the body 100, and at least one of the first and fourth via electrodes 610 and 640 may have the side surface at least partially coplanar with the fourth surface 104 of the body 100.

At least a portion of the first to fourth via electrodes 610, 620, 630, and 640 may be exposed through the third surface 103 or the fourth surface 104 of the body 100, and in contact with the insulating layer 700 covering the body 100.

The third via electrode 630 may pass through the support member 200 to be connected to the third lead portion 343 of the first coil 300 disposed on the upper surface of the support member 200, and may be disposed between the insulating layer 700 covering the third surface 103 of the body 100 and the support member 200.

The fourth via electrode 640 may pass through the support member 200 to be connected to the fourth lead portion 444 of the second coil 400 disposed on the upper surface of the support member 200, and may be disposed between the insulating layer 700 covering the fourth surface 104 of the body 100 and the support member 200.

The coil component 3000 according to the present exemplary embodiment may be formed by disposing the via electrodes 610, 620, 630, and 640 across a dicing line when the coil components are in a state of a coil bar before being diced into an individual component, and then dicing the via electrodes together with the body 100 during a dicing process.

Through this structure, it is possible to reduce volumes occupied by the via electrodes 610, 620, 630, and 640 in the body 100 to thus increase the effective volume of the coil component 3000, thereby improving the inductance characteristic of the coil component. In addition, it is possible to reduce the number of the via hole processing for forming the via electrodes 610, 620, 630, and 640 to thus increase the process efficiency and reduce the occurrence of the defects.

As set forth above, the coil component according to an aspect of the present disclosure may reduce the risk of the short circuit occurring between the external electrodes disposed on the side surfaces of the coil component in the coupled inductor and the short circuit occurring between the external electrode and the part adjacent thereto by minimizing the region of the external electrode disposed on the side surface of the coil component.

The coil component according to another aspect of the present disclosure may have the lower appearance defects such as misalignment occurring between the side surface insulation and the lower surface insulation by simplifying the process of insulating the side surface.

The coil component according to another aspect of the present disclosure may have the improved inductance characteristic by reducing the volume of the via electrode in the body of the coil component to thus increase the effective volume.

While the exemplary embodiments have been shown and described above, it will be apparent to those skilled in the art that modifications and variations could be made without departing from the scope of the present disclosure as defined by the appended claims.

What is claimed is:

1. A coil component comprising:
a body having a first surface and a second surface opposing each other in a first direction, and a third surface and a fourth surface opposing each other and connecting the first surface and second surface to each other;
a support member disposed within the body;
first and second coils disposed on the support member;
first and third external electrodes disposed on the first surface of the body and connected to the first coil;
second and fourth external electrodes disposed on the first surface of the body and connected to the second coil;
a first via electrode disposed within the body and connecting the first coil and the first external electrode to each other; and
a second via electrode disposed within the body and connecting the second coil and the second external electrode to each other,
wherein the third external electrode extends onto the third surface of the body, and the fourth external electrode extends onto the fourth surface of the body.

2. The coil component of claim 1, wherein at least one of the first or second via electrodes is tapered to have a wider cross-sectional area as being closer to the first surface of the body.

3. The coil component of claim 2, wherein each of the first and second via electrodes has one surface in contact with the first and second coil, respectively, and the other surface in contact with the first and second external electrode, respectively,
each of the one surface and the other surface is formed in a circular shape, and
a ratio of a diameter of the other surface of the first via electrode to a diameter of the one surface of the first via electrode is more than 1.05 or a ratio of a diameter of the other surface of the second via electrode to a diameter of the one surface of the second via electrode is more than 1.05.

4. The coil component of claim 1, wherein the body includes first and second cores respectively passing through the support member.

5. The coil component of claim 4, wherein the first coil includes
first and third winding portions, the first winding portion disposed on one surface of the support member and would around the first core, and the third winding portion disposed on an opposite surface of the support member and wound around the first core,
the first via connecting the first and third winding portions to each other,
a first lead portion in contact with the first via electrode,
a third lead portion in contact with the third external electrode, and
first and third extension portions respectively connecting the first and third winding portions and the first and third lead portions to each other, and
the second coil includes
second and fourth winding portions, the second winding portion disposed on one surface of the support member and would around the second core, and the fourth winding portion disposed on an opposite surface of the support member and wound around the second core,
a second via connecting the second and fourth winding portions to each other,
a second lead portion in contact with the second via electrode,
a fourth lead portion in contact with the fourth external electrode, and
second and fourth extension portions respectively connecting the second and fourth winding portions and the second and fourth lead portions to each other.

6. The coil component of claim 5, wherein the first or second via electrode at least partially extends into the first or second lead portion, respectively.

7. The coil component of claim 6, wherein
a ratio of a thickness of a region of the first via electrode extends into the first lead portion in the first direction to a thickness of the first lead portion in the first direction is less than 0.9, or
a ration of a thickness of a region of the second via electrode extends into the second lead portion in the first direction to a thickness of the second lead portion in the first direction is less than 0.9.

8. The coil component of claim 5, wherein the first to fourth winding portions are wound in the same direction.

9. The coil component of claim 5, wherein each of the first to fourth extension portions surrounds the first and second cores together.

10. A coil component comprising:
a body having a first surface and a second surface opposing each other;
a support member disposed within the body;
first and second coils disposed on the support member;
first and third external electrodes disposed on the first surface and connected to the first coil;
second and fourth external electrodes disposed on the first surface and connected to the second coil;
first and third via electrodes disposed within the body, the first via electrode connecting the first coil and the first external electrode to each other, and the second via electrode connecting the first coil and the third external electrode to each other; and
second and fourth via electrodes disposed within the body, the second via electrode connecting the second coil and the second external electrode to each other, and the fourth via electrode connecting the second coil and the fourth external electrode.

11. The coil component of claim 10, wherein the third via electrode passes through the support member to be connected to the first coil, and
the fourth via electrode passes through the support member to be connected to the second coil.

12. The coil component of claim 10, wherein each of the first to fourth via electrodes has one surface in contact with the first coil or the second coil, the other surface in contact with one of the first to fourth external electrodes, and a side surface connecting the one surface and the other surface to each other, and
at least one of the first to fourth via electrodes has the side surface at least partially coplanar with the surface of the body.

13. The coil component of claim 12, wherein the body further has a third surface and a fourth surface opposing each other and connecting the first surface and the second surface to each other,
at least one of the second or third via electrodes has the side surface at least partially coplanar with the third surface, and
at least one of the first or fourth via electrodes has the side surface at least partially coplanar with the fourth surface.

14. The coil component of claim 10, wherein at least one of the first to fourth via electrodes is tapered structure having a wider cross-sectional area as being closer to the first surface.

15. The coil component of claim 10, further comprising an insulating layer disposed on the body and exposing the first to fourth external electrodes,
wherein the insulating layer is in contact with at least a portion of at least one of the first to fourth via electrodes.

16. The coil component of claim 10, wherein the body includes first and second cores respectively passing through the support member,
the first coil includes
first and third winding portions respectively disposed on both surfaces of the support member and wound around the first core,
a first via connecting the first and third winding portions to each other,
first and third lead portions respectively in contact with the first and third via electrodes, and
first and third extension portions respectively connecting the first and third winding portions and the first and third lead portions to each other, and
the second coil includes
second and fourth winding portions respectively disposed on both surfaces of the support member and wound around the second core,
a second via connecting the second and fourth winding portions to each other,
second and fourth lead portions respectively in contact with the second and fourth via electrodes, and
second and fourth extension portions respectively connecting the second and fourth winding portions and the second and fourth lead portions to each other.
